(19) United States
(12) Patent Application Publication
(10) Pub. No.: US 2023/0343368 A1
(43) Pub. Date: Oct. 26, 2023

(54) TOKENIZING A MANIPULATED SHORT-FORM VIDEO

(71) Applicant: Loop Now Technologies, Inc., San Mateo, CA (US)

(72) Inventors: Ziming Zhuang, Palo Alto, CA (US); Wu-Hsi Li, Somerville, MA (US); Jerry Ting Kwan Luk, Menlo Park, CA (US); Michael A Shoss, Milton (CA)

(21) Appl. No.: 18/134,606

(22) Filed: Apr. 14, 2023

Related U.S. Application Data
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.
(60) Provisional application No. 63/437,397, filed on Jan. 6, 2023.
(60) Provisional application No. 63/431,757, filed on Dec. 12, 2022.
(60) Provisional application No. 63/430,372, filed on Dec. 6, 2022.
(60) Provisional application No. 63/424,958, filed on Nov. 14, 2022.
(60) Provisional application No. 63/423,128, filed on Nov. 7, 2022.
(60) Provisional application No. 63/414,604, filed on Oct. 10, 2022.
(60) Provisional application No. 63/413,272, filed on Oct. 5, 2022.
(60) Provisional application No. 63/395,370, filed on Aug. 5, 2022.
(60) Provisional application No. 63/388,270, filed on Jul. 12, 2022.
(60) Provisional application No. 63/351,840, filed on Jun. 14, 2022.
(60) Provisional application No. 63/350,894, filed on Jun. 10, 2022.
(60) Provisional application No. 63/344,064, filed on May 20, 2022.
(60) Provisional application No. 63/332,703, filed on Apr. 20, 2022.
(60) Provisional application No. 63/458,178, filed on Apr. 10, 2023.
(60) Provisional application No. 63/458,458, filed on Apr. 11, 2023.
(60) Provisional application No. 63/458,733, filed on Apr. 12, 2023.

(51) Int. Cl. G11B 27/06; G11B 27/036; G06Q 20/38

(52) U.S. Cl. CPC G11B 27/06; G11B 27/036; G06Q 20/389; G06Q 2220/18

(57) ABSTRACT

Techniques for tokenizing a manipulated short-form video are disclosed. A short-form video is obtained from a short-form environment that includes a short-form video server. The short-form video includes news, weather, traffic information, music, sports highlights, vlog entries, product information, how-to videos, livestream replays, and/or other content. Highlight segments within short-form videos are identified, and a new video is created, based on one or more identified highlight segments. The new video may also be a short-form video. The highlight segments may be from the original short-form video, or may come from a variety of other sources. The new video is used to enhance entertainment value. The new video is tokenized. The tokenization can be used to support ownership identification. The tokenization can be used to create a non-fungible token.

### RELATED APPLICATIONS

This application claims the benefit of U.S. provisional patent applications “Tokenizing A Manipulated Short-Form Video” Ser. No. 63/332,703, filed Apr. 20, 2022, “Short-Form Videos Usage Within A Frame Widget Retail Environment” Ser. No. 63/344,064, filed May 20, 2022, “Manipulating Video Livestream Background Images” Ser. No. 63/350,894, filed Jun. 10, 2022, “Product Card Ecommerce Purchase Within Short-Form Videos” Ser. No. 63/351,840, filed Jun. 14, 2022, “Search Using Generative Model Synthesized Images” Ser. No. 63/388,270, filed Jul. 12, 2022, “Creating And Populating Related Short-Form Video Segments” Ser. No. 63/395,370, filed Aug. 5, 2022, “Object Highlighting In An Ecommerce Short-Form Video” Ser. No. 63/413,272, filed Oct. 5, 2022, “Dynamic Population Of Contextually Relevant Videos In An Ecommerce Environment” Ser. No. 63/414,604 , filed Oct. 10, 2022, “Multi-Hosted Livestream In An Open Web Ecommerce Environment” Ser. No. 63/423,128, filed Nov. 7, 2022, “Cluster-Based Dynamic Content With Multi-Dimensional Vectors” Ser. No. 63/424,958, filed Nov. 14, 2022, “Text-Driven AI-Assisted Short-Form Video Creation In An Ecommerce Environment” Ser. No. 63/430,372, filed Dec. 6, 2022, “Temporal Analysis To Determine Short-Form Video Engagement” Ser. No. 63/431,757, filed Dec. 12, 2022, “Connected Television Livestream-To-Mobile Device Handoff In An Ecommerce Environment” Ser. No. 63/437,397, filed Jan. 6, 2023, “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, and “Dynamic Short-Form Video Transversal With Machine Learning In An Ecommerce Environment” Ser. No. 63/458,733, filed Apr. 12, 2023.

Each of the foregoing applications is hereby incorporated by reference in its entirety.

### FIELD OF ART

This application relates generally to short-form videos and more particularly to tokenizing a manipulated short-form video.

### BACKGROUND

Short-form videos are gaining popularity. Individuals are now able to consume short-form videos from almost anywhere on any connected device at home, in the car, or even walking outside. Especially on mobile devices, social media platforms have become an extremely common use of internet-based video. Accessed through the use of a browser or specialized app that can be downloaded, these platforms include Facebook™, TikTok™, YouTube™, Snapchat™, and Instagram™, among many other services. While these services vary in their video capabilities, they are generally able to display short video clips, repeating video “loops”, livestreams, music videos, etc. These videos can last anywhere from a few seconds to several minutes. Many mobile electronic devices, such as smartphones, tablet computers, and wearable computing devices, include one or more cameras. Some devices may include multiple cameras, including wide-angle, ultrawide, and telephoto lenses, along with stereo microphones. Advanced image processing techniques, such as stabilization, high dynamic range (HDR), selective focus, and various other video effects, empower individuals to create content on their mobile device that would have required a professional studio just a short time ago.

Modern mobile devices can support on-device editing through a variety of applications (“apps”). The on-device editing can include splicing and cutting of video, adding audio tracks, applying filters, and the like. Furthermore, modern mobile devices are typically connected to the Internet via high-speed networks and protocols such as WiFi, 4G/LTE, 5G/OFDM, and beyond. Each time internet speed and bandwidth has improved, devices and technologies which introduce new capabilities have been created. This technology, coupled with the connectivity and portability of these devices, enables high-quality video capture, and fast uploading of video to these platforms. Thus, it is possible to create high-quality content that can be quickly shared with online communities. These communities can range in size from a few members to millions of individuals.

The aforementioned platforms, as well as others, can utilize short-form videos for entertainment, news, advertising, product promotion, and more. Short-form videos give content creators an innovative way to showcase their creations. Leveraging short-form videos can encourage audience engagement, which is of particular interest in product promotion. Users spend many hours online watching an endless supply of videos from friends, family, social media “influencers”, gamers, news sites, favorite sports teams, or a plethora of other sources. The attention span of many individuals is limited. Studies show that short-form videos are more likely to be viewed to completion as compared with longer videos. Hence, the short-form video is taking on a new level of importance in areas such as ecommerce, news, and general dissemination of information. The rise of short-form videos has led to a new level of engagement. While not all of this engagement is productive, users consume vast amounts of video online. As technologies improve and new services are enabled, video consumption will only continue to increase in the future.

### SUMMARY

Short-form videos can be consumed on a wide variety of electronic devices including smartphones, tablet computing devices, televisions, laptop computers, desktop computers, wearable computing devices such as smartwatches, and more. Short-form videos are becoming increasingly relevant for dissemination of information and entertainment. The information can include news and weather information, sports highlights, product information, reviews of products and services, product promotion, educational materials, how-to videos, advertising, and more. Generation of short-form videos is therefore taking on a new importance in light of these trends.

Generation of a new short-form video is accomplished by accessing a library of short-form videos. A first popular short-form video from the library is identified based on the number of views it has received. The first short-form video is then segmented to obtain a highlight segment. The highlight segment is subsequently assembled with a second highlight segment, and a new short-form video is generated. A token associated with the new short-form video is created. The editing of the highlight segment and the second highlight segment can be used to enhance the entertainment value of the video. The highlight segment can be selected based on metadata associated with at least two video segments within the popular short-form video. This metadata can include, but is not limited to, recency of views, reposting rate, user actions, an engagement score for the highlight segment, and/or attributes of a viewer. The user actions can include zoom, volume increase, pause, activation of subtitles or captions, replays, reposts, likes, comments, clicks on advertisements, and so on. The user actions can include entries in a chat window.

The tokenizing of the new short-form video can be used for creating a non-fungible token (NFT). An NFT is a digital asset that associates ownership to unique physical or digital items, such as works of art, real estate, music, or videos. NFTs can be stored in a distributed ledger implemented via a blockchain. Because the blockchain is distributed and made public, the NFT ownership can be easily verified and traced.

NFTs can be purchased via online exchanges and marketplaces. Alternatively, NFTs may be sold at auction. Often, the purchase of NFTs is performed utilizing cryptocurrency such as ether, Bitcoin, or the like. In some cases, a fiat currency can be used for the purchase of an NFT. The NFT may be a fractionalized NFT (F-NFT). A fractionalized NFT can be derived from a single-owner NFT. The single-owner NFT can be fractionalized using a smart contract that generates a set number of tokens linked to the indivisible original. The F-NFT allows multiple parties to claim ownership of a piece of the same NFT. This can be useful for expensive NFTs, allowing more individuals to participate in the trading of NFT items. Collecting and selling NFTs can be a lucrative endeavor. As an example, an NFT of a short-form video clip of a professional basketball player dunking a basketball was sold for over $200,000. In some cases, the NFT may include copyright or licensing rights. In other cases, these may not be included in the purchase of an NFT. Thus, short-form videos can be well suited to the business models enabled by NFTs.

A computer-implemented method for video creation is disclosed comprising: accessing a library of short-form videos; identifying a first popular short-form video from the library of short-form videos, wherein the identifying is based on number of views; segmenting the first popular short-form video to obtain a highlight segment; assembling the highlight segment with a second highlight segment; generating a new short-form video based on the assembling; and creating a token associated with the new short-form video. In embodiments, the token associated with the new short-form video is stored on a blockchain digital ledger. In embodiments, the token is a non-fungible token (NFT). The NFT can include metadata associated with the new short-form video. The token can be a fractional token reflecting partial ownership of the NFT. Some embodiments comprise augmenting the NFT with an addition and creating a new NFT based on the NFT with the addition. In embodiments, the addition includes an audio addition. In embodiments, the addition includes an additional highlight segment.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for creating a short-form video highlight.

FIG. 2 is a flow diagram for editing a short-form video highlight in NFT form.

FIG. 3 is a flow diagram for selecting video manipulation with metadata and effects.

FIG. 4 is a flow diagram for selecting video segments based on metadata.

FIG. 5 is a block diagram of a block chain with video token metadata.

FIG. 6 shows a system block diagram for distribution of short-form videos.

FIG. 7 is a system diagram for manipulating a short-form video.

### DETAILED DESCRIPTION

Techniques for tokenizing a manipulated short-form video are disclosed. A short-form video may originate from a short-form environment that includes a short-form video server. The short-form video can include news, weather, traffic information, music, sports highlights, vlog entries, product information, how-to videos, livestream replays, and/or other content. Highlight segments within short-form videos can be identified, and a new video can be created based on one or more identified highlight segments. The new video may also be a short-form video. The highlight segments may be obtained from the original short-form video, or may come from a variety of other sources.

The Internet, and its various streaming services, have provided an unprecedented amount of content available for viewing. The constantly increasing amount of available content creates competition for views. In this environment, for a video to become popular, compelling content is needed. Disclosed embodiments help create compelling content that enhances entertainment value by automatically assembling highlight segments into a video. The highlight segments create compelling content that is well suited for the short-form video format. The short-form video format is well suited for younger audiences, who may have shorter attention spans. An additional feature of disclosed embodiments is the generation of NFTs that are associated with the generated videos. The NFTs can serve as an additional way for content creators and content owners to monetize content. By selling NFTs, fans of the content get the opportunity to own content from their favorite digital content creators. Supporting fractional NFTs enables multiple parties to own a single piece of digital content. Thus, disclosed embodiments provide techniques for the generation and monetization of compelling content in today's ultra-competitive environment where literally millions of videos are competing for a viewer's attention.

Identifying the highlight segments is essential and can be based on metadata. The metadata can include recency of views, total viewing time, reposting rate, user actions, an engagement score for the highlight segment, and/or attributes of a viewer. The user actions can include, but are not limited to, zoom, volume increase, number of times the video is paused, the duration of time that the video is paused, number of replays, number of reposts, number of likes, comments, or clicks on advertisements. The user actions can include entries in a chat window. The entries may be analyzed by machine learning that performs natural language processing. The natural language processing can be used to determine a valence or sentiment of the entry in the chat window. Positive sentiment can be used as a criterion to select a portion of a video as a highlight segment.

User actions such as number of views, reposts, likes, and replays can be used to determine which short-form videos from a library are good candidates for identifying a highlight segment within them. A predetermined threshold for each user action may be established. When one or more of the thresholds are exceeded, a short-form video may be deemed a candidate for highlight segment identification. As an example, a threshold of five thousand views may be used as a criterion for highlight segment identification. A number of likes can be used to determine if a video is deemed a popular video. As an example, a threshold of five hundred likes may be used as a criterion for considering a video as a popular video, making it eligible for highlight segment identification. Disclosed techniques may use coefficients and/or weights to adjust the combination of factors used in selection of candidate short-form videos. Once selected, the candidate short-form videos are analyzed for identification of highlight segments within them.

The time at which a user action occurred may be used in identification of a highlight segment within a short-form video. When a video is paused, a portion of video starting from before the pause to a point after the pause may be selected. For example, a highlight segment can be created from a portion of video starting from five seconds before the pause to five seconds after the pause. A similar technique can be applied to other user actions such as zoom and volume increase, among others. In some cases, a zoomed portion of a video may be used as a highlight segment. In some cases, a still frame of video from a zoomed portion of a video may be used as a highlight segment. As an example, a still frame may be converted to a highlight segment of a predetermined duration (e.g., five seconds).

A new video can be created based on one or more highlight segments. The new video may also be a short-form video. In some embodiments, the short-form video may have a duration ranging from three seconds to six hundred seconds. In some embodiments, the short-form video may have a duration ranging from three seconds to one hundred seconds. In some embodiments, the short-form video may have a duration ranging from three seconds to sixty seconds. Other ranges may be used in disclosed embodiments. The rate of change of metadata within a highlight segment may also be used as a criterion for highlight segment selection. In embodiments, if the number of likes per minute exceeds a predetermined threshold (e.g., fifty likes per minute), then the highlight segment is selected for inclusion in the new, manipulated video. The ordering of highlight segments within the new, manipulated video can be based on associated metadata. A score may be calculated for each highlight segment that is to be included in a new video. The ordering may be based on the score. The score may be indicative of interest, or generation of an emotion such as surprise, anger, happiness, and the like. As an example, the new video may be created such that the highlight segments are arranged in an order so that the highest generation of emotion comes at the end of the new video. Thus, the new, manipulated video can be used to enhance entertainment value.

The new video can be tokenized. The tokenization can be used to support ownership identification. The tokenization can also be used to create an NFT. An NFT is a digital asset that associates ownership to unique physical or digital items such as works of art, real estate, music, or videos. NFTs can be stored in a distributed ledger implemented via a blockchain. Because the blockchain is distributed and made public, the NFT ownership can be easily verified and traced. The NFT can be a fractional NFT (F-NFT) used to facilitate multi-party ownership of a short-form video. The F-NFT allows multiple parties to claim ownership of a fractional piece of the same item. This can be useful for expensive NFTs, allowing more individuals to participate in the trading of NFT items. The NFTs and/or F-NFTs can be sold at auction and/or traded on online marketplaces. This provides new opportunities for content creators to monetize the videos they make.

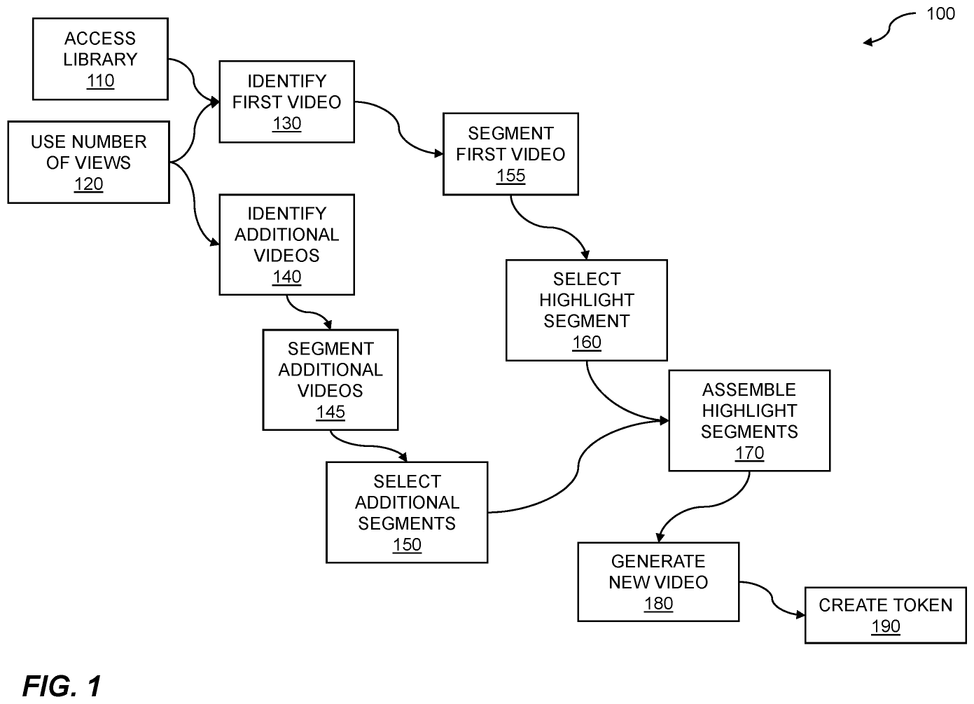

FIG. 1 is a flow diagram for creating a short-form video highlight. Short-form videos can include livestream replays, sports highlights, comedy routines, how-to videos, cooking lessons, news, weather, traffic, advertisements, product reviews, and other genres of content. A popularity metric for a video can be established. The popularity can be based on number of views, duration of viewing, number of reposts, number of shares, number of likes, rate of increase of reposts, rate of increase of shares, rate of increase of likes, and/or other criteria. The number of views can be determined as the number of views within a specific time frame, a number of views by a certain demographic of viewer, a number of views by a social media influencer, and the like. Short-form videos within a library can be identified based on the aforementioned criteria and classified as popular videos. The popular short-form videos are used as candidates for identification of highlight segments. A highlight segment is a portion of a video. Highlight segments can be scored and/or analyzed to determine if they are eligible to be included in a new, manipulated video. The new video may include multiple highlight segments. The new video may be shorter than the original video. In some cases, highlight segments may be obtained from multiple sources. In such cases, the new video may be longer than the original video.

A token can be created that corresponds to the new video. The token may be a digital hash of a video file. In some embodiments, the digital hash may be based on an MD5sum hashing function, a SHA256 hashing function, or some other suitable hashing function. In some embodiments, the digital hash may be based on a salt value that is used as an additional input to the hashing function.

The token can be stored on a distributed ledger such as a blockchain. Blockchains have various properties, including decentralization and immutability. Blockchains can provide enhanced security, greater transparency, and instant traceability. Furthermore, blockchains can provide cost savings from increased speed, efficiency, and automation. By greatly reducing paperwork and errors, and reducing disputes regarding ownership and chain of custody, blockchains significantly reduce overhead and transaction costs, and reduce or eliminate the need for third parties or middlemen to verify transactions. These important features impede the ability to forge or falsify data pertaining to the information stored in the blockchain. In some embodiments, a copy of the blockchain may be stored on an associated electronic computing device, and/or cloud storage location. Adding new blocks utilizes a consensus algorithm. A proof-of-work, proof-of-stake, or other suitable approach helps maintain integrity of the blockchain. The blockchain can be used to support NFTs associated with short-form videos. The NFTs can be fractional NFTs (F-NFTs). The NFTs can be auctioned and/or sold at online exchanges, online marketplaces, and the like. The NFTs enable new monetization opportunities for content creators. The flow 100 includes accessing a library 110. The library 110 can include multiple short-form videos. The short-form videos can be stored in the library, and/or references (links) to the videos can be stored in the library. The videos can be identified and placed in the library by a content aggregation system, or another suitable technique.

The flow includes using the number of views 120 as a criterion for deeming a video a popular video. In embodiments, a predetermined threshold is established for a video. When the number of views exceeds the predetermined threshold, the video is deemed a popular video, and is eligible for highlight segment selection. In embodiments, the predetermined threshold may be based on a content genre or type. As an example, a short-form video on professional soccer may have a first predetermined threshold for views, and a short-form video on professional badminton may have a second predetermined threshold for views, wherein the second predetermined threshold is a different value than the first predetermined threshold. Continuing with this example, since professional soccer has a wider audience than professional badminton, the different thresholds enable an assessment of video popularity based on video genre and/or subject matter. Continuing with the example, while a badminton video with two thousand views may be considered popular, a soccer video may use a threshold requiring 200,000 views before it is deemed popular. Thus, embodiments can use a genre-specific threshold for number of views for popular video identification. In some embodiments, a number of unique views may be used instead of, or in addition to, a total number of views. A unique view is a view from a particular device. In embodiments, browser cookies and/or other analytical tools may be used to determine unique views. In some embodiments, a ratio of unique views to total views may be used as a criterion for deeming a video a popular video.

The flow includes identifying a first video 130 based on the number of views exceeding a predetermined threshold. The flow continues with segmenting the first video 155. The segmenting can be based on shot transition detection, which can include abrupt transitions, as well as gradual transitions such as fades and wipes. Shots are a sequence of frames captured by a single camera in a particular time period. In embodiments, an image processing library such as OpenCV is utilized to identify shots from within a video. In some embodiments, continuity of audio is also used as a criterion for identifying segments. Highlight segments can include one or more shots from a video.

The flow includes selecting a highlight segment 160. The highlight segment can be selected based on a variety of criteria, including metadata. The metadata can include user actions. The user actions can include zoom, volume increase, pause, replays, reposts, activation of subtitles, likes, or clicks on advertisements. The user actions can be used as a measure of engagement for a highlight segment. An engagement score can be computed based on the user actions. When the engagement score exceeds a predetermined value, a highlight segment is selected for inclusion in a new, manipulated video. As an example, when users tend to pause a video at a certain point, a highlight segment comprising a certain amount of footage before and after the pause can be included as a highlight segment. Similarly, when users tend to increase volume of a video at a certain point, a highlight segment comprising a certain amount of footage before and after the point of volume increase can be included as a highlight segment. Similarly, when users tend to zoom in during a video at a certain point, a highlight segment comprising a certain amount of footage before and after the point of zoom can be included as a highlight segment. In some embodiments, the selecting is based on the rate of change of metadata associated with the highlight segment.

The flow can include identifying additional videos 140. The identifying of additional videos can be performed using similar criteria to the identifying the first video 130. In embodiments, metadata such as genre, author, and/or another category may be used for identifying additional videos. The metadata for identifying additional videos can include user actions. The user actions can include zoom, volume increase, pause, replays, reposts, activation of subtitles, likes, or clicks on advertisements. The metadata used for identifying additional videos can include recency of views, reposting rate, an engagement score for the highlight segment, and/or attributes of a viewer.

The flow can include segmenting the additional videos 145. The segmenting of the additional videos may be performed in a manner similar to that for segmenting the first video 155. The segmenting can be based on shot transition detection, which can include abrupt transitions, as well as gradual transitions such as fades and wipes. Shots are a sequence of frames captured by a single camera in a particular time period. In embodiments, an image processing library such as OpenCV is utilized to identify shots from within a video. In some embodiments, continuity of audio is also used as a criterion for identifying segments. Highlight segments can include one or more shots from a video.

The flow can include selecting additional segments 150. The additional segments can be selected in a manner similar to the selecting of the highlight segment 160. The highlight segment can be selected based on a variety of criteria, including metadata. The metadata can include user actions. The user actions can include zoom, volume increase, pause, replays, reposts, activation of subtitles, likes, or clicks on advertisements. The user actions can be used as a measure of engagement for a highlight segment. An engagement score can be computed based on the user actions. When the engagement score exceeds a predetermined value, a highlight segment is selected for inclusion in a new, manipulated video.

The flow can include assembling highlight segments 170. The highlight segments may be assembled sequentially. In some embodiments, the highlight segments are ordered. The ordering can be based on temporal data such as time/date of recording, length of the highlight segments, and/or other criteria. In some embodiments, the ordering is based on an engagement score. In embodiments, the highlight segments are arranged in an order of an increasing engagement score, such that each subsequent highlight segment has a higher engagement score than the previous segment. The engagement score is a measure of how engaging or interesting a highlight segment is. In embodiments, the engagement score is derived from crowdsourced metadata. The metadata can include user actions. The user actions can include zoom, volume increase, pause, replays, reposts, activation of subtitles, likes, or clicks on advertisements. The flow can include generating a new video 180. The new, manipulated video contains one or more highlight segments selected at 160 and/or 150, which are then assembled at 170.

The flow can include creating a token 190. In embodiments, the token is based on a one-way mathematical function. The token can be based on a checksum. The token can be derived from a hashing algorithm, such as MD5sum, SHA256, or another suitable hashing algorithm. The token may be stored in a distributed ledger, such as a blockchain. In embodiments, the token may be a non-fungible token (NFT) or a fractional NFT (F-NFT). The NFT or F-NFT may be stored on a blockchain.

Embodiments can include a computer-implemented method for video creation comprising: accessing a library of short-form videos; identifying a first popular short-form video from the library of short-form videos, wherein the identifying is based on number of views; segmenting the first popular short-form video to obtain a highlight segment; assembling the highlight segment with a second highlight segment; generating a new short-form video based on the assembling; and creating a token associated with the new short-form video. In some embodiments, the token is a non-fungible token (NFT). In some embodiments, the token is a fractional token reflecting partial ownership of the NFT. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

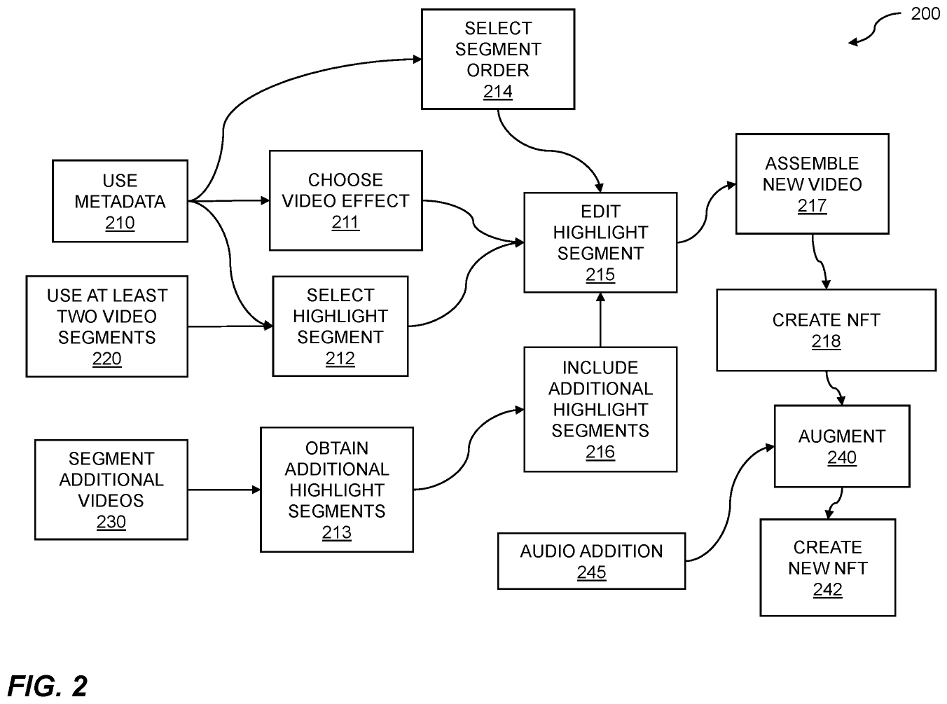

FIG. 2 is a flow diagram 200 for editing a short-form video highlight in NFT form. Disclosed embodiments identify candidate short-form videos, segment the candidate short-form videos to create candidate highlight segments, and then select a subset of the candidate highlight segments for inclusion in a new, manipulated video. The highlight segments may be arranged sequentially in the new video. In some embodiments, the highlight segments may be displayed simultaneously in individual display windows within a video. As an example, a picture-in-picture display may be used, with a first highlight segment filling the entire area of the video, and a second highlight video displayed in a smaller sub-window within the area of the video and displayed in front of the first highlight video. In some embodiments, the first video is displayed with translucency using alpha-blending, compositing, and/or other techniques, such that the first highlight segment and the second highlight segment are both visible on the full video display simultaneously. A variety of transition effects, such as fades, dissolves, and wipes, may be used to transition from a first highlight segment to a second highlight segment. Additional audio may be added to the new, manipulated video. The additional audio can include voiceover, sound effects, translations, and/or other audio information. Once the new video is assembled, an NFT that is associated with the new video can be created. The NFT can be used to confirm and track ownership of the new video.

The flow can include using metadata 210. The metadata can be used as criteria for selecting a highlight segment and/or selecting the order of highlight segments. The metadata can include user actions. The user actions can include zoom, volume increase, pause, replays, reposts, activation of subtitles, likes, or clicks on advertisements.

The flow can include using at least two video segments 220. The flow can include segmenting additional videos 230. The videos can be livestream replays, sports highlights, news clips, instructional videos, educational videos, and/or other video types. In some embodiments, the video being segmented can be a television show, a movie, or a sporting event. Such a video being segmented can be longer and can have a duration of 30 minutes, 60 minutes, 120 minutes, or some other length.

The flow can include choosing a video effect 211. In embodiments, the choosing of video effects is performed automatically by a computer-implemented method. The computer-implemented method may choose a video effect randomly, or based on user preferences established via a user profile. The video effects can include, but are not limited to, changes in speed, reflections, color grading, chroma keying, image stabilization, color-correction, cropping, panning, motion tracking, grayscale, rotation, and/or other video effects. The video effects can include transition effects such as fades, dissolves, and wipes.

The flow can include selecting a highlight segment 212. The highlight segment can be selected based on a variety of criteria, including metadata. The metadata can include user actions. The user actions can include zoom, rotation, panning, volume increase, pause, replays, reposts, activation of subtitles, likes, or clicks on advertisements. The user actions can be used as a measure of engagement for a highlight segment. An engagement score can be computed based on the user actions. In embodiments, the engagement score is based on crowdsourced information.

In embodiments, when the engagement score exceeds a predetermined value, a highlight segment is selected for inclusion in a new, manipulated video. As an example, when users tend to pause a video at a certain point, a highlight segment comprising a certain amount of footage before and after the pause can be included as a highlight segment. Similarly, when users tend to increase volume of a video at a certain point within a video, a highlight segment comprising a certain amount of footage before and after the point of volume increase can be included as a highlight segment. Similarly, when users tend to zoom in during a video at a particular point within a video, a highlight segment comprising a certain amount of footage before and after the point of zoom can be included as a highlight segment. In some embodiments, the selecting is based on rate of change of metadata associated with the highlight segment.

The flow can include obtaining additional highlight segments 213 from the additional videos. The flow can include editing a highlight segment. The editing of the highlight segment can include a playback speed change. As an example, for a sports clip highlight segment, the editing can include converting the highlight segment to slow motion. In some embodiments, the slow-motion speed may be 25 percent of the original playback speed.

The flow can include selecting segment order 214. The ordering can be based on temporal data, such as time/date of recording, length of the highlight segments, and/or other criteria. In some embodiments, the ordering is based on an engagement score. In embodiments, the highlight segments are arranged in an order of increasing engagement score, such that each subsequent highlight segment has a higher engagement score than the previous segment. The engagement score is a measure of how engaging or interesting a highlight segment is. In embodiments, the engagement score is derived from crowdsourced metadata. The metadata can include user actions. The user actions can include zoom, volume increase, pause, replays, reposts, activation of subtitles, likes, or clicks on advertisements. The flow can include editing the highlight segment 215. The editing can include color correction, trimming, sound equalization, sound effects, and/or additional editing operations.

The flow can include additional highlight segments 216. The additional highlight segments can also undergo editing as previously described. The flow can include assembling a new video 217. The new video can include one or more highlight segments. In embodiments, the new video is also a short-form video. In some embodiments, the new video has a length that exceeds short-form video limits. In embodiments, a second popular short-form video is segmented to obtain a second highlight segment, and the second highlight segment is included in the new short-form video.

The flow can include creating an NFT 218. The NFT can be stored on a distributed ledger that is implemented via a blockchain. Blockchains have various properties, including decentralization and immutability. These features impede the ability to forge or falsify data pertaining to the information stored in the blockchain. In some embodiments, a copy of the blockchain may be stored on an associated electronic computing device and/or cloud storage location. Adding new blocks utilizes a consensus algorithm. A proof-of-work, proof-of-stake, or other suitable approach helps maintain integrity of the blockchain.

The flow can include augmenting 240. The augmenting can include an audio addition 245. The audio addition can include voiceover, a descriptive video service track, an alternative language track, sound effects, additional sound channels to facilitate surround sound, and/or other audio information. The augmenting can include editing, deleting, and/or adding highlight segments. The flow can include creating a new NFT 242 corresponding to the augmented video. In this way, different versions of a video can have a different NFT associated with them, and each version can be owned by different parties. Thus, disclosed embodiments facilitate new opportunities for monetization of content. Marketplaces and online auctions promote purchasing and sale of NFTs associated with short-form videos.

In embodiments, the NFT includes metadata associated with the short-form video. Embodiments can include augmenting the NFT with an addition and creating a new NFT based on the NFT with the addition. In embodiments, the addition includes an audio addition. In embodiments, the addition includes an additional highlight segment. In embodiments, the second highlight segment is obtained during the segmenting of the first popular short-form video. In embodiments, the second highlight segment is obtained from a second popular short-form video. In embodiments, the assembling further comprises editing the highlight segment and the second highlight segment to enhance entertainment value. In embodiments, the editing includes selection of order for the highlight segment and the second highlight segment. Embodiments can include ordering the highlight segments based on metadata. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

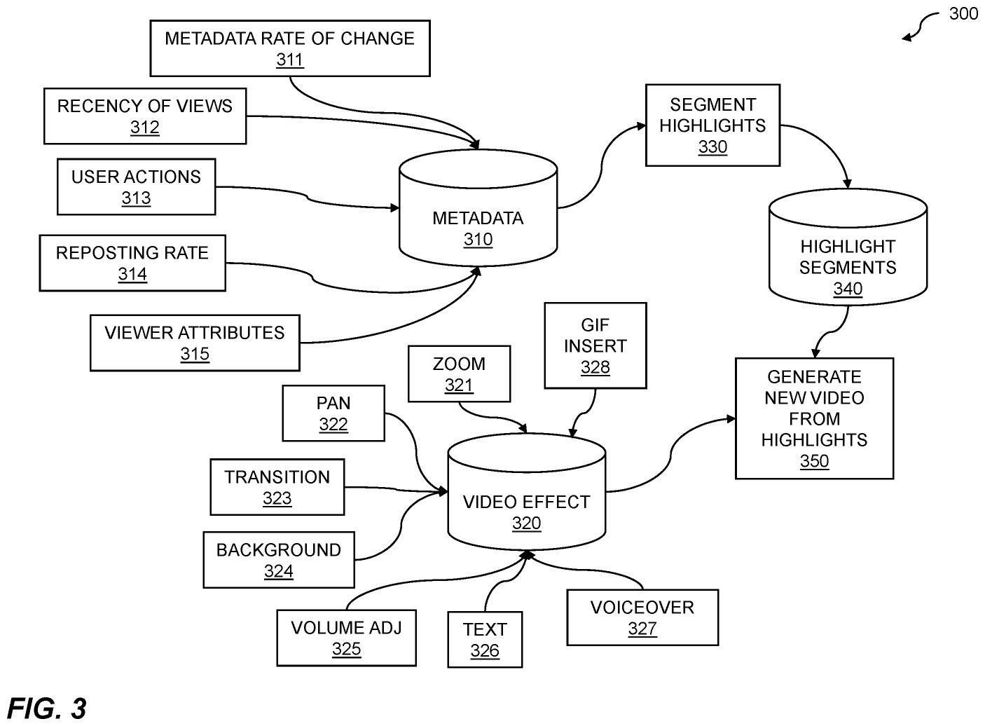

FIG. 3 is a flow diagram 300 for selecting video manipulation with metadata and effects. The flow depicted in FIG. 3 may be implemented via computer-implemented methods. In embodiments, machine learning systems may be used to select and/or assemble highlight videos. In embodiments, a neural network can be used to rank videos and/or assign an engagement score to each highlight segment. The neural network can include a neural network for machine learning, for deep learning, and so on. The neural network can be trained (e.g., can learn) to assist the ranking engine by ranking videos based on the training. The training can include applying a training dataset to the neural network, where the training dataset includes videos and known results of inferences associated with the videos.

The flow can include obtaining metadata 310. The metadata can include recency of views 312, user actions 313, reposting rate 314, an engagement score for the highlight segment, and/or viewer attributes 315. A metadata rate of change 311 may also be used in some embodiments. In embodiments, an increase in the number of views per minute, and/or an increase in the number of likes per minute, can be used as criteria in selection of videos and/or highlight segments. A reposting rate is representative of how many times per a given time interval a short-form video is shared (e.g., via social media). In embodiments, a reposting rate that exceeds a predetermined value can be used as criteria in selection of videos and/or highlight segments. Viewer attributes can include demographic information, location information, user platform information, and/or other information. The user platform information can include device information, operating system information, memory capacity, video codecs installed, and/or other platform-specific information.

Recency of views can include a tally of the number of views that occurred within the previous hour, or some other suitable duration. In embodiments, a recent view tally that exceeds a predetermined value can be used as criteria in selection of videos and/or highlight segments.

The flow can include a video effect 320. The video effect can include zoom 321, pan 322, transition 323, background 324, volume adjustment 325, text 326, and/or voiceover 327. In embodiments, the zoom is performed by a user manipulating his/her fingers on a touchscreen of an electronic device using a pinch or reverse pinch motion to change the scaling of displayed video. In embodiments, a timestamp within the video at the time of the zoom is obtained. Using crowdsourcing techniques, when a zoom is detected frequently in a particular area of a video or highlight segment by multiple users, it can signify content of increased interest. Thus, embodiments can include using the zoom metadata for identifying candidate videos and highlight segments for inclusion in a new video.

In embodiments, a timestamp within the video at the time of a volume adjustment is obtained. Using crowdsourcing techniques, when a volume adjustment is detected frequently in a particular area of a video or highlight segment, it can signify content of increased interest. Thus, using the volume adjustment metadata can be a useful technique for identifying videos and highlighting segments in disclosed embodiments.

In embodiments, the pan is performed by a user manipulating his/her fingers on a touchscreen of an electronic device using a swipe motion to pan the displayed video. In embodiments, a timestamp within the video at the time that the pan is obtained. Using crowdsourcing techniques, when a pan is detected frequently in a particular area of a video or highlight segment, it can signify content of increased interest. Thus, embodiments can include using the pan metadata for identifying candidate videos and highlighting segments for inclusion in a new video. The aforementioned user actions may utilize a timestamp within the video to associate user actions (e.g., volume adjustment, zoom, etc.) with a particular point within the video.

In some embodiments, the assembling includes a video effect. In some embodiments, the video effect includes a zoom, pan, transition, special background, volume adjustment, voiceover, or text. Embodiments can include choosing the video effect based on metadata. In embodiments, the metadata includes recency of views, reposting rate, user actions, an engagement score for the highlight segment, and/or attributes of a viewer.

In embodiments the video effect includes a transition. The transition can occur between a first highlight segment and a second highlight segment. In embodiments, the first highlight segment is faded out while the second highlight segment is faded in. Other transitions, such as wipes, dissolves, and others, may be used in disclosed embodiments.

In embodiments, the video effect includes text. The text can be descriptive text that pertains to a highlight segment. The text can include metadata pertaining to the highlight segment. In embodiments, the text can include the date the highlight segment was created. In embodiments, the text can include the current owner of the highlight segment and/or short-form video. The current owner may be retrieved from a distributed ledger implemented via a blockchain. The text can include the sale price for the short-form video based on the sale of an NFT corresponding to the short-form video. The text can include captioning of a language track, or subtitles in alternate language that correspond to a language track of the short-form video.

In embodiments, the video effect includes a voiceover. The voiceover can include a description for the highlight segments to enable visually-impaired users to follow the highlight segments. The voiceover can include text-to-speech audio generated by a computer. The text-to-speech audio can include comments entered into a chat window, or comments scraped from social media systems that posted the short-form video and/or highlight segments.

In embodiments, the video effect includes a GIF insert 328. A GIF is an image format that supports both animated and static images. In embodiments, an animated GIF can be inserted into the new video at the end of a highlight segment. The animated GIF can include text. In embodiments, the text can be related to the highlight video. As an example, after a highlight video of a basketball player dunking a basketball in a hoop, an animated GIF of a donut being dunked into a coffee cup, with the word “dunk” rendered in the GIF, can be appended. This can serve to make more compelling videos with highlight segments, thereby enhancing entertainment value.

The flow can include segmenting highlights 330. The segmenting can be based on shot transition detection, which can include abrupt transitions as well as gradual transitions such as fades and wipes. Shots are a sequence of frames captured by a single camera in a particular time period. In embodiments, an image processing library such as OpenCV is utilized to identify shots from within a video. In some embodiments, continuity of audio is also used as a criterion for identifying segments. Highlight segments can include one or more shots from a video.

The flow can include aggregation of highlight segments 340. The highlight segments can be concatenated to generate a new video from highlights 350. The generation of the new video can include transcoding to a new format and/or scaling to a new resolution. The new video can have video effects applied to alter the appearance and/or sound from the original source of the highlight segments. The new video can be posted on a social media site, shared via e-mail, and/or distributed in another manner. In some embodiments, the new video may be automatically posted to a social media site, along with computer generated tags that can allow potential buyers to easily find the video and any corresponding NFTs. A token that corresponds to the new video can be generated. The token can be used as an NFT or F-NFT for supporting sale/ownership of the new video via a distributed ledger implemented by a blockchain. The NFTs may be linked to digital wallet addresses to enable sale of the NFTs.

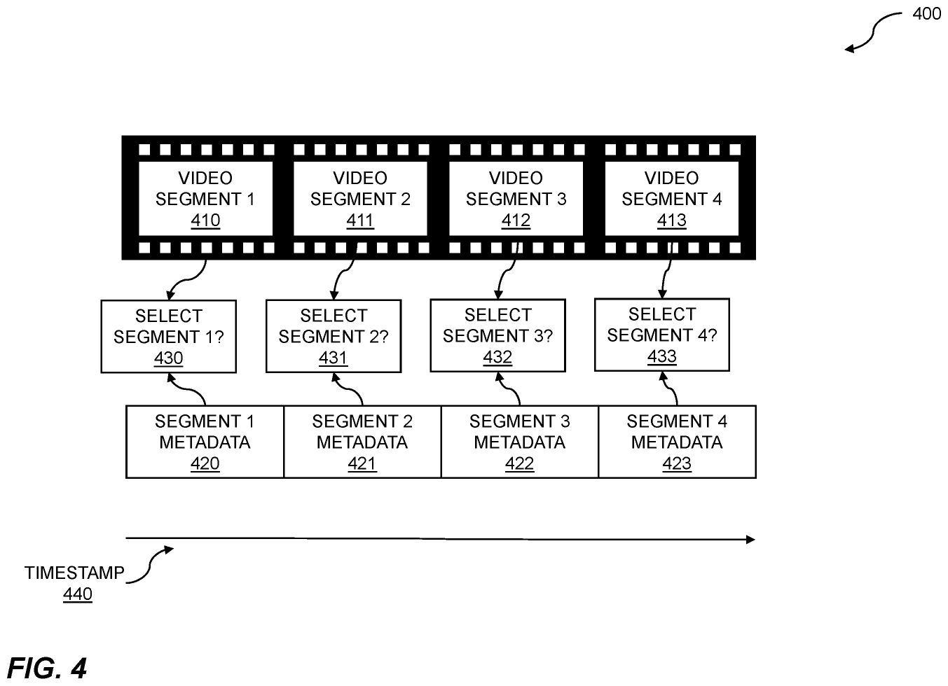

FIG. 4 is a flow diagram 400 for selecting video segments based on metadata. Video segments can be identified via shot transition detection, which can include abrupt transitions, as well as gradual transitions such as fades and wipes. Shots are a sequence of frames captured by a single camera in a particular time period. In embodiments, an image processing library such as OpenCV is utilized to identify shots from within a video. In some embodiments, continuity of audio is also used as a criterion for identifying segments. In some embodiments, periods of continuous audio are considered as a segment. A period of silence exceeding a predetermined threshold (e.g., three seconds) may be used as a marker to denote the start and/or end of a segment. Highlight segments can include one or more shots from a video.

The flow includes a first video segment 410, a second video segment 411, a third video segment 412, and a fourth video segment 413. Note that while four video segments are shown in FIG. 4, in practice, there can be many thousands of video segments included in the flow. Each of the video segments (410, 411, 412, 413) is a candidate video segment. The flow includes determining if a candidate segment qualifies to be selected for use in a new video. The flow includes a decision for selecting segment 1 at 430. The flow includes a decision for selecting segment 2 at 431. The flow includes a decision for selecting segment 3 at 432. The flow includes a decision for selecting segment 4 at 433.

The selection criteria for selecting a segment can include segment metadata. The segment metadata can include media information, including date of creation, date of last modification, file size, image resolution, sound quality, encoding format, language, platform used for recording, geographic location, and/or other metadata items. The metadata can include, but is not limited to, recency of views, reposting rate, user actions, an engagement score for the highlight segment, and/or attributes of a viewer. The user actions can include, but are not limited to, zoom, volume increase, pause, replays, reposts, likes, comments, or clicks on advertisements. The user actions can include entries in a chat window.

Segment 1 metadata 420 is used as criteria for selection of segment 1 430. Segment 2 metadata 421 is used as criteria for selection of segment 2 431. Segment 3 metadata 422 is used as criteria for selection of segment 3 432. Segment 4 metadata 423 is used as criteria for selection of segment 4 433. Note that while four segments are shown in FIG. 4, in practice there can be many thousands of segments, each segment having its own associated metadata. In embodiments, the metadata can be gathered via crowdsourcing techniques. In embodiments, a rendering device, such as a smartphone, tablet computer, laptop computer, or the like, sends a message to a system in accordance with disclosed embodiments. The message contains a data structure that includes a user action, and a corresponding timestamp indicating when, within a video, the user action occurred. The user actions and timestamps can be tallied and averaged by the system to determine points in a video where the user actions tend to occur. User actions such as pausing, rewinding, increasing volume, and/or other user actions having a high occurrence at a particular point or time window within a video, may be used as criteria to determine that a highlight segment is to be included in a new, manipulated video.

The flow includes a timestamp 440. The timestamp can be used to denote where, within the new video, a segment is to be included. Once a segment is selected for inclusion in a new video, a timestamp can be added to its associated metadata, indicating its temporal position within the new video. Thus, the ordering of highlight segments within the new, manipulated video can be based on associated metadata. A score may be calculated for each highlight segment that is to be included in a new video. The ordering may be based on the score. The score may be indicative of interest, or generation of an emotion such as surprise, anger, happiness, or the like. As an example, the new video may be created such that the highlight segments are arranged in an order so that the highest generation of emotion comes at the end of the new video. Thus, the new, manipulated video can be used to enhance entertainment value.

In embodiments, the segmenting further comprises selecting the highlight segment based on metadata associated with at least two video segments within the popular short-form video. In embodiments, the user actions include zoom, volume increase, pause, replays, reposts, likes, or clicks on advertisements. In some embodiments, the user actions include entries in a chat window. In some embodiments, the user actions include rotating a mobile screen to view the new short-form video at different angles.

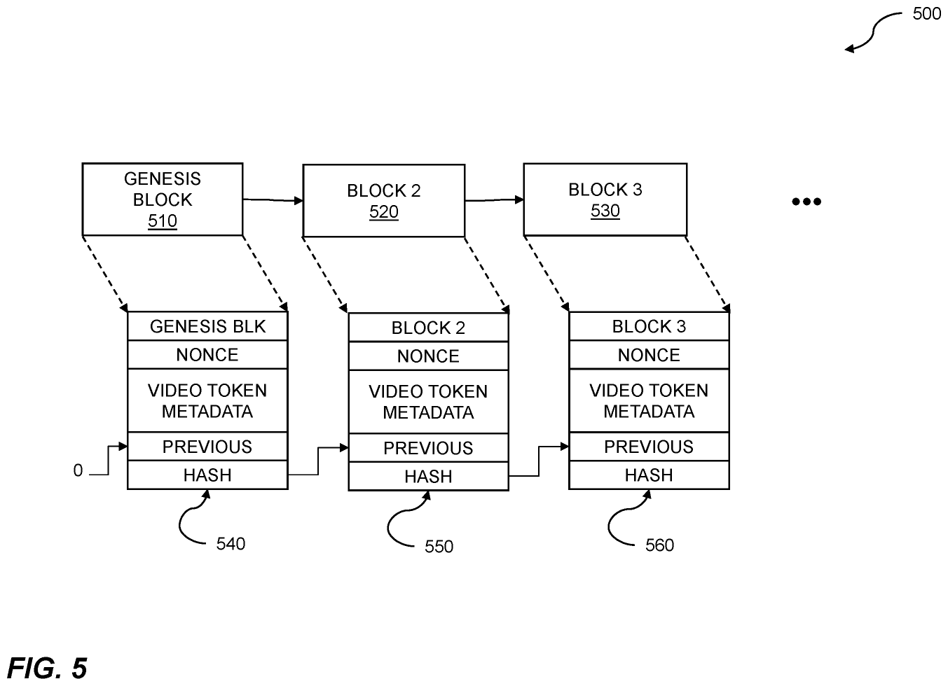

FIG. 5 is a block diagram 500 of a blockchain with video token metadata in accordance with disclosed embodiments. A blockchain such as that shown in FIG. 5 may be stored on multiple computer-implemented blockchain servers. The blockchain includes a first block, which is also referred to as a genesis block 510. Each block may include multiple data sections. In embodiments, block 510 contains a nonce, which can be a randomly generated, unique number. The nonce may be used for cryptographic and/or authentication functions. Block 510 contains video token metadata. The video token metadata can include metadata about a short-form video. The metadata can include authorship information, ownership information, copyright information, license information, video subject information, and other relevant information. The video subject information can include a topic for the video, a list of people and/or things appearing in the video, the date of the video creation, the date of the last video modification, the duration of the video, the resolution of the video, and/or other video subject information. In embodiments, the token associated with the new short-form video is stored on a blockchain digital ledger. The block 510 contains a value of the previous hash. Since block 510 is a genesis block, the value of the previous hash is set to a constant. In embodiments, the previous hash is set to zero in the genesis block. However, in some embodiments, the previous hash is set to a non-zero default value in the genesis block. A hash 540 of contents of block 510 is computed.

Block 2 520 is the next block in the blockchain. Block 2 is of a similar structure to block 510. The hash 540 of block 510 is used as the previous hash within block 2 520. As part of creation of block 2 520, a hash 550 of the contents of block 2 520 is computed and appended to the block 520. When the next block, block 3 530 is created, the previous hash filed for block 3 530 uses the value of hash 550. A new hash 560 is computed for block 530, which will be stored as a previous hash in the next block in the blockchain. In embodiments, the hash may be computed by MD5sum or another suitable algorithm. Whenever metadata, including ownership metadata is changed, a new block is added to the blockchain depicted in FIG. 5. While three blocks are shown in FIG. 5, in practice, there can be many thousands of blocks on the blockchain, with a new block added each time metadata pertaining to a short-form video is changed, added, and/or deleted.

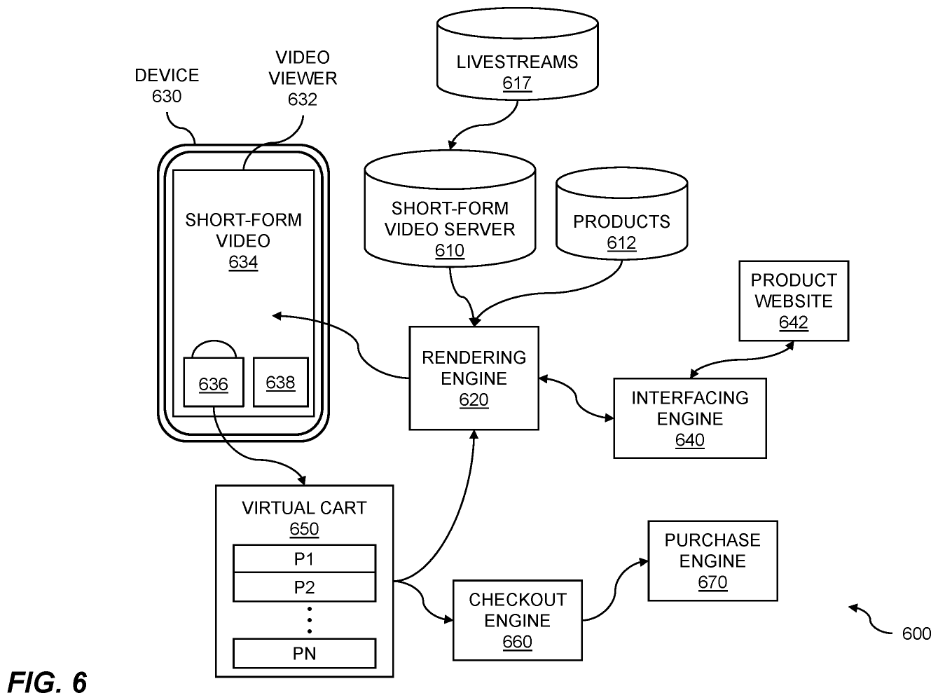

FIG. 6 shows a system block diagram 600 for distribution of short-form videos. The system block diagram 600 can include a short-form video server 610. The short-form video server can include a local server, a remote server, a cloud server, a distributed server, and so on. The short-form video server can deliver a short-form video from a plurality of short-form videos. The short-form videos stored on the server can be uploaded by individuals, content providers, influencers, tastemakers, and the like. The system block diagram 600 can further include one or more lists of products 612. The lists of products can include products that can appear within one or more of the short-form videos. The one or more products that appear within a given short-form video can be available for sale. A user viewing a short-form video can purchase the one or more products by interacting with the products within the short-form video. The system block diagram can include a rendering engine 620. The rendering engine can render a short-form video and one or more products for display. The short-form video that is rendered can be rendered on a display associated with a device 630. The rendering the short-form video can be accomplished using a video viewer 632. The video viewer can include a video app, a web browser, and so on. The short-form video 634 can be displayed on a portion of the display associated with the device. Other portions of the device can be occupied by a representation of a virtual purchase cart 636, product information 638, and/or other relevant information.

The system block diagram can include livestreams 617. In embodiments, the short-form video includes livestream replays. The livestreams can be input to the short-form video server 610 for storage, and selected for generation of highlight segments. In addition to product videos and livestreams, a wide variety of short-form videos, which can include videos pertaining to news, weather, sports, educational, entertainment, comedy, how-to, and/or other topics, can be resident on short-form video server 610.

A user can obtain further information associated with a product in which the user is interested. The system block diagram 600 can include an interfacing engine 640. The interfacing engine can be used to access the further product information and to provide that information for rendering by the rendering engine. The interfacing engine can obtain information from a product website 642. The third party can include an online retailer, a service provider, an influencer, a tastemaker, a celebrity, and the like. Product information obtained from the third-party website can be rendered and displayed. The display of the product information can occupy a portion of the display screen associated with the device. In embodiments, the product information occupies substantially a third of the display screen.

The user can interact with the video user interface. The interacting can include common actions, gestures, and so on, utilized by a user as they interact with a device such as a personal electronic device. In embodiments, the user interaction can be accomplished by mousing over an object in the video. The mousing can in turn be accomplished by moving a cursor with a mouse device, sliding a digit over a trackpad, and the like. In other embodiments, the user interaction can be accomplished by clicking on an object in the video. The clicking can include clicking a button on a mouse device, tapping a trackpad, etc. In further embodiments, the interfacing can include a request for further information on an object, based on the user interaction. An object can include a product or service, an item used by a person present in the website content, an item presented by the person, and the like. Interaction by the user with a product within the video can cause the product to be selected and added to a virtual cart. The system block diagram can include a virtual purchase cart 650. The virtual purchase cart, which can include a virtual shopping cart, a virtual shopping bag, a virtual tote, etc., can include one or more products selected for purchase by the user. The products can include product P1, product P2, and so on, up to product PN. In embodiments, a representation of the virtual purchase cart can be displayed on the device. The representation is visible while viewing the short-form video. Information associated with the virtual purchase cart and its contents can be provided to the rendering engine for display on the device. In embodiments, an option to purchase an NFT corresponding to a product may also be presented to the user.

The virtual purchase cart can be checked out. The system block diagram can include a checkout engine 660. The checking out can include verifying that the items selected by the user while viewing the short-form video are in stock; that information such as size, color, or configuration has been provided; etc. When sufficient product information has been collected, final purchase of the products can be accomplished. The system block diagram can include a purchase engine 670. The purchase engine can collect information required to finalize the one or more purchases. The information can include payment information such as credit card number and expiration date; contact information such as mailing address, email address, and phone number; shipping preferences; etc. By the end of the short-form video, the user can select all the products they want to purchase so that the purchase can be finalized. In embodiments, the finalizing purchase can be accomplished using a batch order process. The batch order processing can enable all items purchased from a given vendor to be placed on the same order rather than creating one order for each item.

In some embodiments, the purchase information may be stored in a digital ledger implemented via a blockchain. The purchase information may be used as part of an NFT for sale. As an example, a short-form video that resulted in the first sale of a high-profile and/or limited-edition product may have high value on an NFT exchange and/or auction site. In embodiments, information pertaining to the product sold based on the video is integrated into the video token metadata for that video.

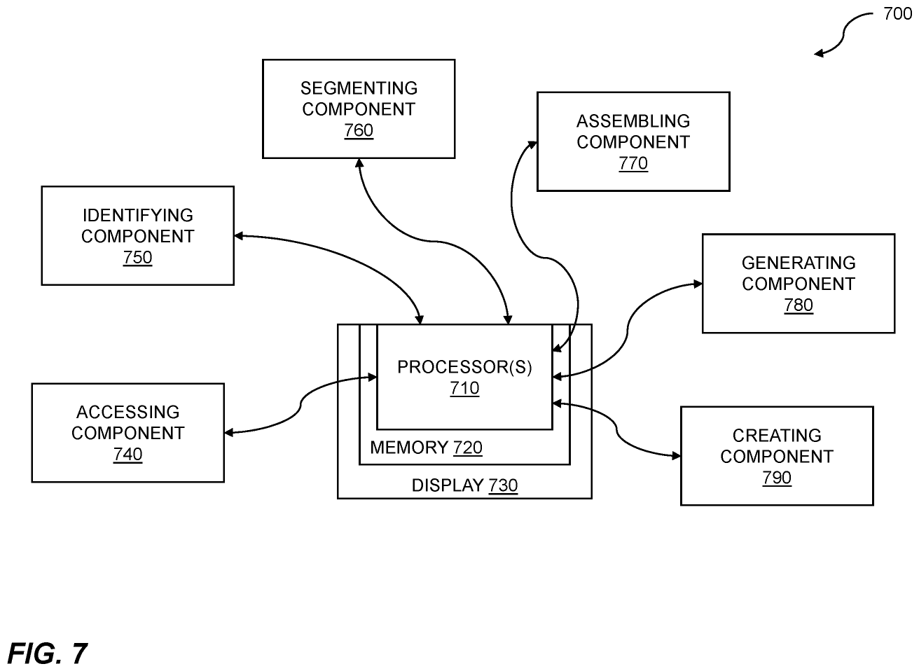

FIG. 7 is a system diagram 700 for manipulating a short-form video. Multiple highlight segments from one or more sources may be used to create a new short-form video. The short-form video can include a prerecorded video, a livestream video, and so on. The system 700 can include one or more processors 710 attached to a memory 720 which stores instructions. The system 700 can include a display 730 coupled to the one or more processors 710 for displaying data, video streams, videos, video metadata, product information, NFT information, virtual purchase cart contents, webpages, intermediate steps, instructions, and so on. In embodiments, one or more processors 710 are attached to the memory 720 where the one or more processors, when executing the instructions which are stored, are configured to: access a library of short-form videos; identify a first popular short-form video from the library of short-form videos, wherein the identifying is based on number of views; segment the first popular short-form video to obtain a highlight segment; assemble the highlight segment with a second highlight segment; generate a new short-form video based on the assembling; and create a token associated with the new short-form video.

The system 700 can include an accessing component 740. The accessing component 740 can include functions and instructions for accessing one or more short-form videos from a short-form video server. The short-form video server can be a server accessible via a computer network, such as a LAN (local area network), WAN (wide area network), and/or the Internet. In some embodiments, the short-form video server may expose APIs for searching and retrieval of short-form videos. The accessing component 740 may utilize the APIs for obtaining short-form videos.

The system 700 can include an identifying component 750. The identifying component 750 can include functions and instructions for identifying one or more short-form videos as candidates for identifying highlight segments within those short-form videos. The identifying component 750 may utilize metadata for the identification process. This metadata can include, but is not limited to, recency of views, reposting rate, user actions, an engagement score for the highlight segment, and/or attributes of a viewer. The user actions can include, but are not limited to, zoom, volume increase, pause, replays, reposts, likes, comments, or clicks on advertisements. The user actions can include entries in a chat window.

The system 700 can include a segmenting component 760. The segmenting component 760 can include functions and instructions for segmenting one or more short-form videos into highlight segments. The segmenting can be based on shot transition detection, which can include abrupt transitions, as well as gradual transitions such as fades and wipes. Shots are a sequence of frames captured by a single camera in a particular time period. In embodiments, an image processing library such as OpenCV is utilized to identify shots from within a video. In some embodiments, continuity of audio is also used as a criterion for identifying segments. Highlight segments can include one or more shots from a video.

The system 700 can include an assembling component 770. The assembling component 770 can include functions and instructions for assembling one or more highlight segments together. The assembling component 770 can include functions and instructions for the ordering of highlight segments. The ordering of highlight segments can be based on associated metadata. The ordering can be based on temporal data, such as time/date of recording, length of the highlight segments, and/or other criteria. A score may be calculated for each highlight segment that is to be included in a new video. The ordering may be based on the score. The score may be indicative of interest, or generation of an emotion such as surprise, anger, happiness, or the like.

The system 700 can include a generating component 780. The generating component 780 can include functions and instructions for generating a new, manipulated short-form video. The generating component 780 can include functions and instructions for transcoding, format conversion, insertion of transitions, special effects, filters, audio track manipulation, and/or other functions to create a new short-form video that contains one or more highlight segments obtained by the segmenting component 760 and assembled by the assembling component 770. The output of the generating component 780 may be a short-form video. The short-form video may be stored on a short-form video server for storage and access purposes.

The system 700 can include a creating component 790. The creating component 790 can include functions and instructions for creating a token associated with a short-form video generated by the generating component 780. The token can be created using a hashing function. The hashing function can be a MD5sum hashing function, SHA256 hashing function, or another suitable hashing function. The token may be stored in a distributed ledger that is implemented via a blockchain. The token may be an NFT or F-NFT indicative of ownership of a digital asset. The digital asset can be a short-form video. The sale of an NFT may take place on an online marketplace, online auction site, or other suitable site.

The system 700 can include a computer program product embodied in a non-transitory computer readable medium for accessing a library of short-form videos, the computer program product comprising code which causes one or more processors to perform operations of: accessing a library of short-form videos; identifying a first popular short-form video from the library of short-form videos, wherein the identifying is based on number of views; segmenting the first popular short-form video to obtain a highlight segment; assembling the highlight segment with a second highlight segment; generating a new short-form video based on the assembling; and creating a token associated with the new short-form video.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video creation comprising:
accessing a library of short-form videos;
identifying a first popular short-form video from the library of short-form videos, wherein the identifying is based on number of views;
segmenting the first popular short-form video to obtain a highlight segment;
assembling the highlight segment with a second highlight segment;
generating a new short-form video based on the assembling; and
creating a token associated with the new short-form video.

2. The method of claim 1 wherein the token associated with the new short-form video is stored on a blockchain digital ledger.

3. The method of claim 1 wherein the token is a non-fungible token (NFT).

4. The method of claim 3 wherein the NFT includes metadata associated with the new short-form video.

5. The method of claim 3 wherein the token is a fractional token reflecting partial ownership of the NFT.

6. The method of claim 3 further comprising augmenting the NFT with an addition and creating a new NFT based on the NFT with the addition.

7. The method of claim 6 wherein the addition includes an audio addition.

8. The method of claim 6 wherein the addition includes an additional highlight segment.

9. The method of claim 1 wherein the new short-form video includes livestream replays.

10. The method of claim 1 wherein the segmenting further comprises selecting the highlight segment based on metadata associated with at least two video segments within the first popular short-form video.

11. The method of claim 10 wherein the metadata includes recency of views.

12. The method of claim 10 wherein the metadata includes attributes of a viewer.

13. The method of claim 10 wherein the metadata includes reposting rate.

14. The method of claim 10 wherein the metadata includes an engagement score for the highlight segment.

15. The method of claim 10 wherein the metadata includes user actions.

16. (canceled)

17. The method of claim 15 wherein the user actions include rotating a mobile screen to view the new short-form video at different angles.

18. The method of claim 15 wherein the user actions include entries in a chat window.

19. The method of claim 10 wherein the selecting is based on rate of change of metadata associated with the highlight segment.

20. The method of claim 1 wherein the assembling includes a video effect.

21. (canceled)

22. The method of claim 20 further comprising choosing the video effect based on metadata.

23. The method of claim 1 wherein the second highlight segment is obtained during the segmenting the first popular short-form video.

24. The method of claim 1 wherein the second highlight segment is obtained from a second popular short-form video.

25. The method of claim 1 wherein the assembling further comprises editing the highlight segment and the second highlight segment to enhance entertainment value.

26. The method of claim 25 wherein the editing includes selection of order for the highlight segment and the second highlight segment.

27. The method of claim 26 further comprising ordering the highlight segments based on metadata.

28. The method of claim 1 further comprising segmenting a second popular short-form video to obtain a second highlight segment and including the second highlight segment in the new short-form video.

29. A computer program product embodied in a non-transitory computer readable medium for video creation, the computer program product comprising code which causes one or more processors to perform operations of:
accessing a library of short-form videos;
identifying a first popular short-form video from the library of short-form videos, wherein the identifying is based on number of views;
segmenting the first popular short-form video to obtain a highlight segment;
assembling the highlight segment with a second highlight segment;
generating a new short-form video based on the assembling; and
creating a token associated with the new short-form video.

30. A computer system for video creation comprising:
a memory which stores instructions;
one or more processors attached to the memory wherein the one or more processors, when executing the instructions which are stored, are configured to:
access a library of short-form videos;
identify a first popular short-form video from the library of short-form videos, wherein identification is based on number of views;
segment the first popular short-form video to obtain a highlight segment;
assemble the highlight segment with a second highlight segment;
generate a new short-form video based on assembling; and
create a token associated with the new short-form video.
